(19) United States
(12) Patent Application Publication
(10) Pub. No.: US 2013/0162086 A1
(43) Pub. Date: Jun. 27, 2013

(54) PERMANENT MAGNET APPARATUS

(71) Applicant: NATIONAL CHENG KUNG UNIVERSITY, Tainan City (TW)

(72) Inventors: Ray-Lee LIN, Tainan City (TW); Lung-Shing LIN, Kaohsiung City (TW)

(73) Assignee: NATIONAL CHENG KUNG UNIVERSITY, Tainan City (TW)

(21) Appl. No.: 13/713,874

(22) Filed: Dec. 13, 2012

(30) Foreign Application Priority Data
Dec. 23, 2011 (TW) 100148399

(51) Int. Cl. H02K 21/00

(52) U.S. Cl. CPC H02K 21/00; Y10S 74/09; H02K 53/00
USPC 310/152; 74/DIG. 9

(57) ABSTRACT

A permanent magnet apparatus includes a rotor structure and a stator structure. The rotor structure has a first permeance element and a plurality of first magnetic elements. The outer periphery of the first permeance element has a plurality of grooves which are disposed separately. The first magnetic elements are disposed correspondingly in the grooves. The stator structure is disposed at the outer periphery of the rotor structure, and includes a second permeance element and a plurality of second magnetic elements around the rotor structure.

### CROSS REFERENCE TO RELATED APPLICATIONS

This Non-provisional application claims priority under 35 U.S.C. §119(a) on Patent Application No(s). 100148399 filed in Taiwan, Republic of China on Dec. 23, 2011, the entire contents of which are hereby incorporated by reference.

### BACKGROUND OF THE INVENTION

1. Field of Invention

The present invention relates to a permanent magnet apparatus and, in particular, to a permanent magnet apparatus composed of a stator and a rotor both configured with permanent magnets.

2. Related Art

Howard R. Johnson discloses a rotational and linear permanent magnetic motor in U.S. Pat. No. 4,151,431. In this permanent magnetic motor, the rotor can be driven to rotate or move with the attractive and repulsive forces between the permanent magnets of the stator and rotor. Since the magnet force of the permanent magnets in the permanent magnetic motor is limited, many researchers have involved into the development of novel permanent magnetic materials, which are smaller and lighter, and have magnet force. Accordingly, the manufactured permanent magnetic motor can be smaller and lighter, and have larger torque, so that it can be easily applied to every field in our environment.

However, in the rotational permanent magnetic motor disclosed by Howard R. Johnson, the permanent magnets of the stator and the rotor are configured at different relative positions, so that the issue of cogging torque exists. That is, the change of the output torque of the permanent magnetic motor is obvious, so that the permanent magnetic motor has the cogging problem. The cogging can not only cause the vibration and noise of the permanent magnetic motor, but also impact the lifespan of the permanent magnetic motor. In addition, the linear permanent magnetic motor disclosed by Howard R. Johnson has smaller output driving force due to its structural design.

Therefore, it is an important subject of the present invention to provide a rotational permanent magnetic apparatus that can decrease the cogging torque, increase its lifespan, and have higher output torque and structural strength.

Besides, it is also an important subject of the present invention to provide a linear permanent magnetic apparatus that can increase the output driving force.

### SUMMARY OF THE INVENTION

In view of the foregoing subjects, an objective of the present invention is to provide a permanent magnetic apparatus that can decrease the cogging torque, increase its lifespan, and have higher output torque and structural strength.

In view of the foregoing subjects, another objective of the present invention is to provide a permanent magnetic apparatus that can increase the output driving force.

To achieve the above objective, the present invention discloses a permanent magnet apparatus including a rotor structure and a stator structure. The rotor structure has a first permeance element and a plurality of first magnetic elements. The outer periphery of the first permeance element has a plurality of grooves disposed separately, and the first magnetic elements are correspondingly disposed in the grooves. The stator structure is disposed at the outer periphery of the rotor structure, and has a plurality of second magnetic elements around the rotor structure.

In one embodiment, the first magnetic elements are disposed in the grooves, respectively, by wedging, locking, adhering, or their combinations.

In one embodiment, the first magnetic elements are closely attached to the grooves respectively.

In one embodiment, the permanent magnet apparatus further includes a shaft disposed through the first permeance element.

In one embodiment, the stator structure further has a second permeance element disposed around the rotor structure, and the second magnetic elements are disposed in the second permeance element.

In one embodiment, the second magnetic elements are disposed in the second permeance element, respectively, by wedging, locking, adhering, or their combinations.

In addition, the present invention also discloses a permanent magnet apparatus including a stator structure and a rotor structure. The stator structure has a first permeance element, a plurality of first magnetic elements, and a plurality of second permeance element. The first magnetic elements are separately disposed at one side of the first permeance element and form a plurality of separate grooves. The second permeance elements are correspondingly disposed in the grooves. The rotor structure has at least a second magnetic element disposed opposite to the stator structure.

In one embodiment, the second permeance elements are disposed in the grooves by wedging, locking, adhering, or their combinations.

In one embodiment, the second permeance elements are closely attached to the grooves respectively.

In one embodiment, the first permeance elements and the second permeance elements are integrally formed as one piece.

As mentioned above, in the rotational permanent magnetic apparatus of the present invention, the outer periphery of the first permeance element of the rotor structure has a plurality of grooves disposed separately, and the first magnetic elements are correspondingly disposed in the grooves, respectively. Accordingly, the magnetic flux density between two first magnetic elements is increased. Compared with the convention rotational permanent magnetic motor (disclosed by Howard R. Johnson), the present invention can generate larger attractive and repulsive forces when the first magnetic element of the rotor structure is located opposite to the second magnetic element of the stator structure. This configuration can generate larger net torque to drive the rotor structure to rotate, so that the permanent magnetic apparatus of the present invention can have larger output torque. In addition, since the first permeance element is disposed between two first magnetic elements of the rotor structure, compared with the conventional rotational permanent magnetic motor, the rotor structure of the present invention has stronger structural strength. Thus, the lifespan of the present permanent magnetic apparatus is increased.

In the linear permanent magnetic apparatus of the present invention, the first magnetic elements are separately disposed at one side of the first permeance element and form a plurality of separate grooves, and the second permeance elements are correspondingly disposed in the grooves. Accordingly, the magnetic flux density between two first magnetic elements of the stator structure is increased. Compared with the convention linear permanent magnetic motor (disclosed by Howard R. Johnson), the present invention can generate larger attractive and repulsive forces when the first magnetic element of the stator structure is located opposite to the second magnetic element of the rotor structure. This configuration can output larger net force than the conventional linear permanent magnetic motor does. Thus, the permanent magnetic apparatus of the present invention has larger output driving force.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a cross-sectional view of a permanent magnetic apparatus according to a preferred embodiment of the present invention;

FIGS. 2A and 2B are perspective diagrams showing different aspects of the first permeance element of the present invention;

FIG. 3 is a schematic diagram showing the comparison result between the output torques of the permanent magnetic apparatus of the present invention and the conventional rotational permanent magnetic motor disclosed by Howard R. Johnson;

FIG. 4A is a schematic diagram showing another permanent magnetic apparatus according to the preferred embodiment of the present invention;

FIG. 4B is a schematic diagram showing the movement of the linear permanent magnetic apparatus of the present invention; and

FIG. 5 is a schematic diagram showing the comparison result between the output net forces of another permanent magnetic apparatus of the present invention and the conventional linear permanent magnetic motor disclosed by Howard R. Johnson.

### DETAILED DESCRIPTION OF THE INVENTION

The present invention will be apparent from the following detailed description, which proceeds with reference to the accompanying drawings, wherein the same references relate to the same elements.

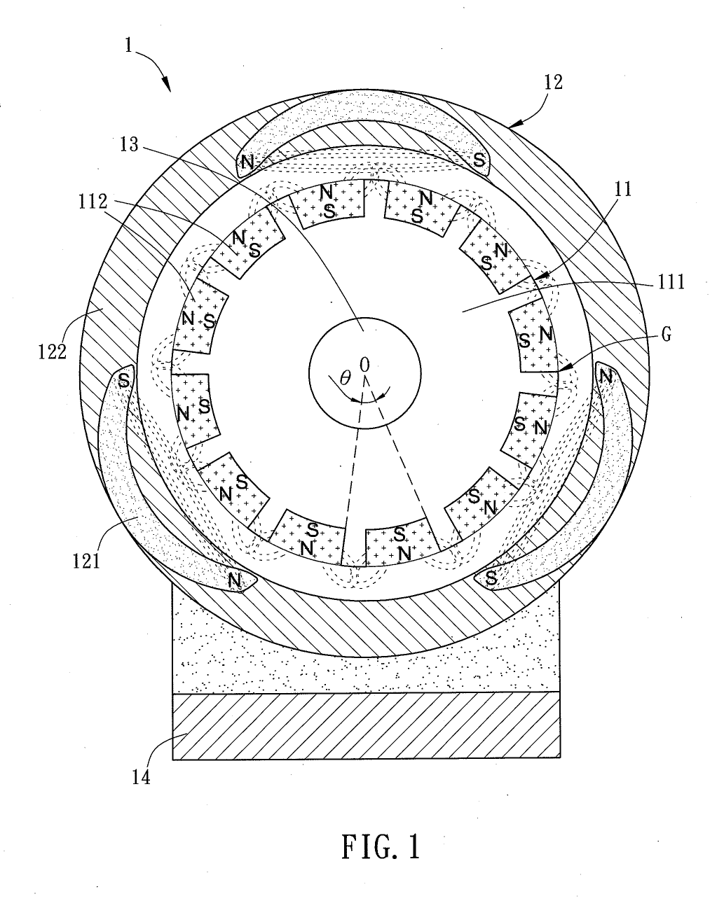

FIG. 1 is a cross-sectional view of a permanent magnetic apparatus 1 according to a preferred embodiment of the present invention. To be noted, the permanent magnetic apparatus 1 of this embodiment is a rotational permanent magnetic motor.

The permanent magnetic apparatus 1 includes a rotor structure 11 and a stator structure 12. The stator structure 12 is disposed at the outer periphery of the rotor structure 11, and an air gap exists between the rotor structure 11 and the stator structure 12. In this case, the rotor structure 11 has a first permeance element 111 and a plurality of first magnetic elements 112, and the outer periphery of the first permeance element 111 has a plurality of grooves G disposed separately.

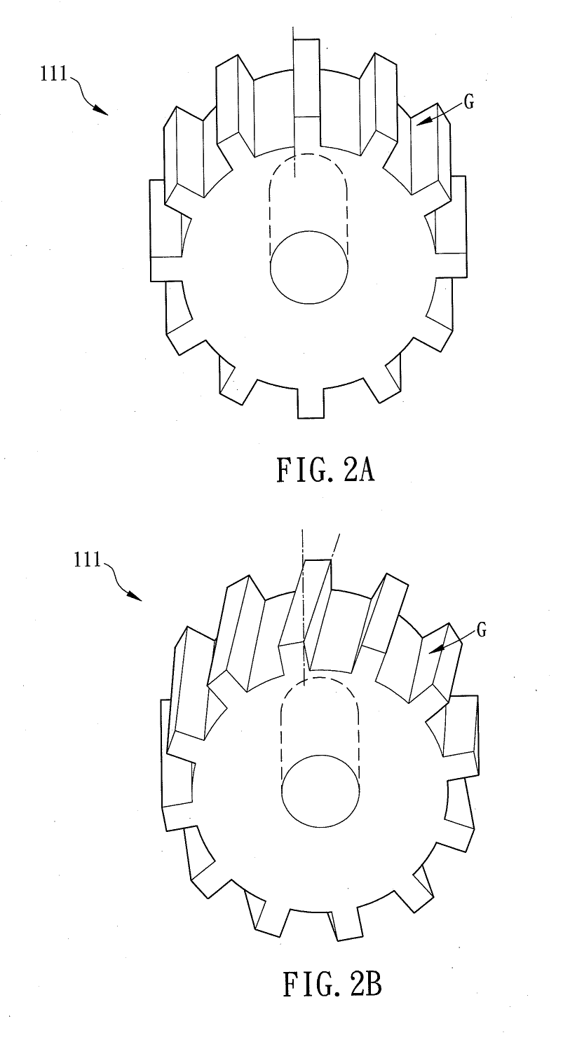

FIGS. 2A and 2B are perspective diagrams showing different aspects of the first permeance element 111 of the present invention.

Referring to FIG. 2A, the first permeance element 111 is a hollow cylinder, and the periphery thereof has a plurality of grooves G disposed separately. The teeth located at two sides of the groove G are substantially parallel to the axial direction of the cylinder. Otherwise, as shown in FIG. 2B, the teeth located at two sides of the groove G may be tilted with a proper angle. In this case, the shape of the first permeance element 111 is not limited to these aspects shown in FIGS. 2A and 2B, and the tilted angle is not limited to that of FIG. 2B.

Referring to FIG. 1 again, the first magnetic elements 112 are correspondingly disposed in the grooves G. In this embodiment, one end of the first magnetic element 112 close to the stator structure 12 is an N pole, while the opposite end is an S pole, and vice versa. The first magnetic elements 112 can be disposed in the grooves G, respectively, by wedging, locking, adhering, or their combinations, and they are closely attached to the grooves G respectively. Herein, “closely attached” means that there is no air gap existing between the first magnetic element 112 and the groove G. In other words, the first magnetic elements 112 can be disposed in the grooves G, respectively, by wedging and adhering or by locking and adhering, and they are closely attached to the grooves G for fixing the first magnetic elements 112 to the grooves G respectively. As shown in FIG. 1, the first permeance element 111 and the first magnetic elements 112 substantially construct a non-salient surface, so that the shape of the entire rotor structure 11 is substantially a non-salient cylinder or disk. Compared with the conventional rotational permanent magnetic motor, this invention can increase the structural strength of the rotor structure 11.

In this embodiment, the numbers of the first magnetic elements 112 and the grooves G are both 12. As shown in FIG. 1, the angle θ configured by a first magnetic element 112, a groove G and the center O of the first permeance element 111 is 30 degrees (=360/12).

The stator structure 12 is disposed at the periphery of the rotor structure 11, and has a plurality of second magnetic elements 121 around the rotor structure 11. In this embodiment, as shown in FIG. 1, the number of the second magnetic elements 121 is 3, and the shape of the second magnetic element 121 is arcuate bowed configuration. One end of the second magnetic element 121 is an N pole, while the opposite end is an S pole, and vice versa. Besides, the length of the second magnetic element 121 may be greater than the sum of the widths of two first magnetic elements 112 and at least one first permeance element 111.

To be noted, the rotational permanent magnetic apparatus 1 of the invention is not limited to include 12 first magnetic elements 112 and 3 second magnetic elements 121. In other aspects, the numbers of the first and second magnetic elements can be different. In addition, if the number of the first magnetic elements is decreased, the width of the second magnetic element 121 must be increased. According to this rule, the number of the first magnetic elements 112 may be changed.

The stator structure 12 may further include a second permeance element 122 disposed around the rotor structure 11, and the second magnetic elements 121 are disposed in the second permeance element 122. In this case, the second magnetic elements 121 are evenly disposed in the second permeance element 122 and located around the rotor structure 11. In practice, the second magnetic elements 121 are disposed in the second permeance element 122 by wedging, locking, adhering, or their combinations. Herein, the second magnetic elements 121 are disposed in the second permeance element 122 by wedging.

The first magnetic elements 112 and the second magnetic elements 121 are permanent magnets. The first permeance element 111 and the second permeance element 122 have high relative permeability (between thousands and tens thousands). For example, the first permeance element 111 and the second permeance element 122 can be made of a soft magnetic composite (SMC) material, which is selected from iron, nickel, cobalt, Fe—Ni alloy, Fe—Ni—Mo alloy, Fe—Al alloy, Fe-based amorphous alloy, Fe-based nanocrystalline alloy, powder made by crushing soft ferrite magnet, and their combinations.

In addition, the permanent magnet apparatus 1 may further include a shaft 13 disposed through the first permeance element 111 of the rotor structure 11. When the first magnetic elements 112 of the rotor structure 11 and the second magnetic elements 121 of the stator structure 12 are attracted and/or repulsed by each other to generate a driving force to rotate the rotor structure 11, the shaft 13 is rotated accordingly. Besides, the permanent magnet apparatus 1 may further include a base 14 for carrying the stator structure 12.

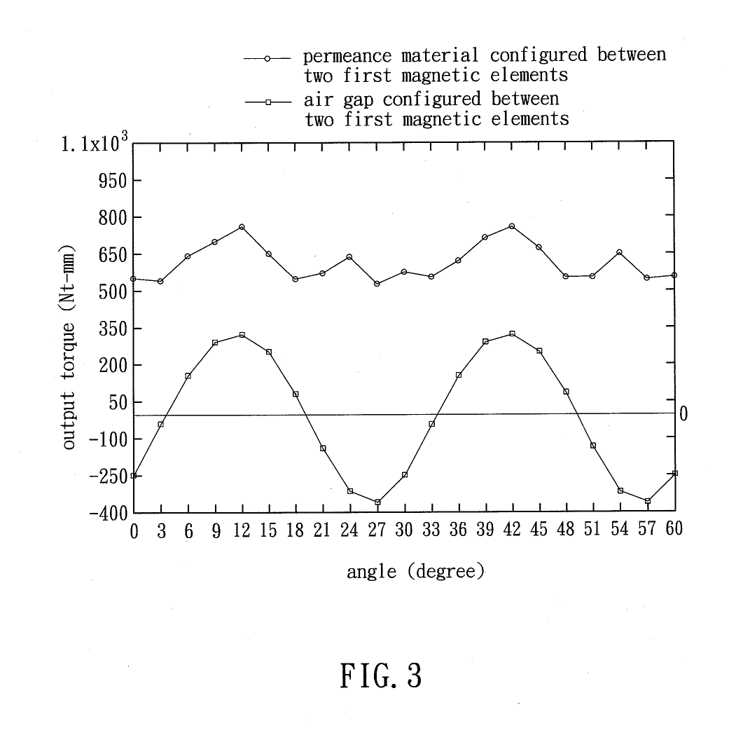

FIG. 3 is a schematic diagram showing the comparison result between the output torques of the permanent magnetic apparatus 1 of the present invention and the conventional rotational permanent magnetic motor disclosed by Howard R. Johnson. In FIG. 3, the X-coordinate represents the angle θ as shown in FIG. 1, and the Y-coordinate represents the output torque (Nt−mm) of the permeance apparatus (motor). As shown in FIG. 1, the angle θ, which is configured by the first magnetic element 112, the groove G and the center O of the first permeance element 111, is 60 degrees. Besides, the circles shown in FIG. 3 represent the output torques of the permanent magnetic apparatus 1 of the present invention, while the squares represent the output torques of the conventional rotational permanent magnetic motor disclosed by Howard R. Johnson, which has an air gap between two first magnetic elements, and the second permeance element 122 is air.

As shown in FIG. 3, in the rotor structure 11 of the permanent magnetic apparatus 1 of the present invention, the space between two first magnetic elements 112 is occupied by the first permeance element 111. Under different angles, the output torques of the permanent magnetic apparatus 1 are all sufficiently greater than that of the conventional rotational permanent magnetic motor, and the variation of the output torques of the permanent magnetic apparatus 1 is relatively smaller. Since the permanent magnetic apparatus 1 has smaller variation in output torques, it is possible to decrease the cogging torque and increase the lifespan thereof. Besides, the permanent magnetic apparatus 1 has higher output torque, and the rotor structure 11 thereof has higher structural strength.

As mentioned above, the conventional rotational permanent magnetic motor disclosed by Howard R. Johnson has an air gap between two rotor permanent magnets. Since the relative permeability of air is 1, the generated magnetic flux density between two rotor permanent magnets is lower. Thus, when the rotor permanent magnets are opposite to the stator permanent magnets, the generated attractive and repulsive forces are smaller. Contrarily, in the rotational permanent magnetic apparatus 1 of the present invention, the first permeance element 111 instead of the air gap is configured between two first magnetic elements 112 forming the rotor structure 11. Since the first permeance element 111 has higher relative permeability, the generated magnetic flux density between two magnetic elements 112 is higher. Thus, when the first magnetic elements 112 are opposite to the second magnetic elements 121, the generated attractive and repulsive forces are larger. Accordingly, a larger net force can be generated to drive the rotor structure 11 to rotate, thereby allowing the permanent magnetic apparatus 1 to have larger output torque. In addition, since the first permeance element 111 is configured between two first magnetic elements 112, the structural strength of the rotor structure 11 is stronger than the conventional design so as to increase the lifespan of the permanent magnetic apparatus 1.

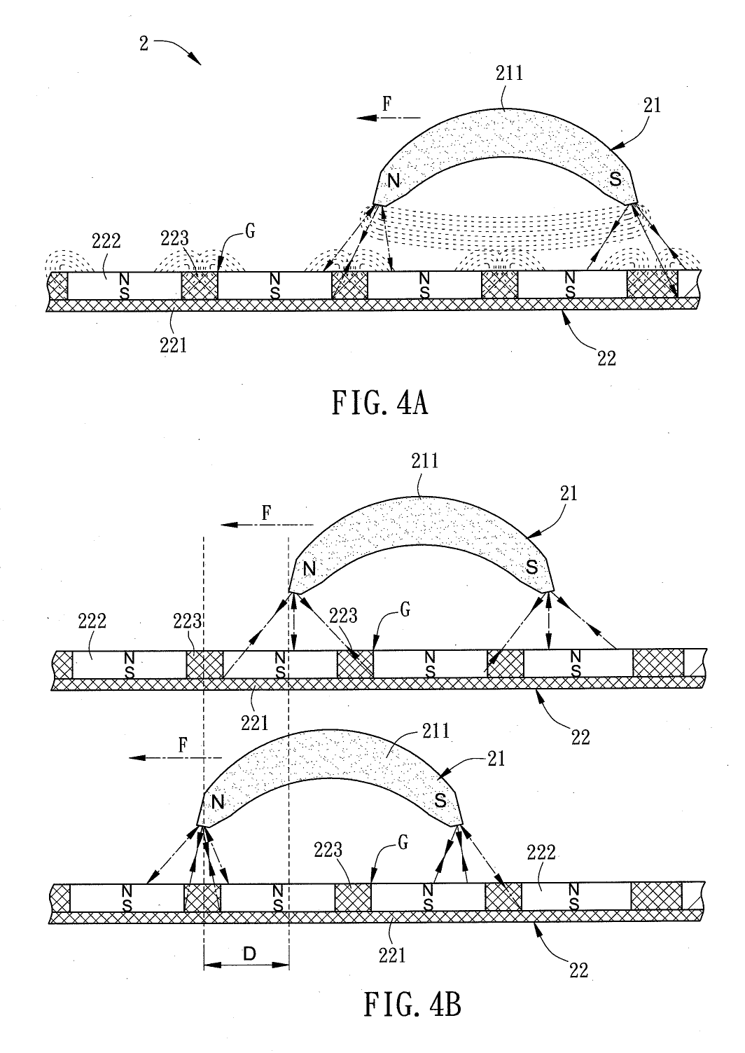

FIG. 4A is a schematic diagram showing another permanent magnetic apparatus 2 according to the preferred embodiment of the present invention. To be noted, the permanent magnetic apparatus 2 of this embodiment is a linear permanent magnetic motor.

Referring to FIG. 4A, the permanent magnetic apparatus 2 includes a rotor structure 21 and a stator structure 22, which are located opposite to each other.

The stator structure 22 has a first permeance element 221, a plurality of first magnetic elements 222, and a plurality of second permeance element 223. The first magnetic elements 222 are separately disposed at one side of the first permeance element 221, which is close to the rotor structure 21, and form a plurality of separate grooves G. The second permeance elements 223 are correspondingly disposed in the grooves G, respectively. The first permeance element 221 and the second permeance element 223 can be integrally formed as one piece or separate components. In this case, the first permeance element 221 and the second permeance elements 223 are separate components, so that the second permeance elements 223 can be disposed in the grooves G by wedging, locking, adhering or their combinations. Accordingly, the second permeance elements 223 can be closely attached in the grooves G. The meanings of “close attached” is described hereinabove, so it is not explained again here. Besides, one end of the first magnetic element 222 close to the stator structure 21 is an N pole, while the other end thereof is an S pole, and vice versa.

The rotor structure 21 has at least one second magnetic element 211 disposed opposite to the stator structure 22. FIG. 4 shows that the rotor structure 21 of this embodiment includes one second magnetic element 211. Of course, it is also possible to configure several second magnetic elements 211 (e.g. 3 second magnetic elements) opposite to the stator structure 22. The features of the first magnetic element 222 and the second magnetic element 211 are similar to those of the above-mentioned first magnetic element 112 and second magnetic element 121, so the detailed descriptions thereof will be omitted. In addition, the technical features of the first permeance element 221 and the second permeance element 223 are similar to those of the above-mentioned first permeance element 111 and second permeance element 122, so the detailed descriptions thereof will be omitted.

The poles of the first magnetic element 222 can attract or repulse the poles of the second magnetic element 211. Besides, since the second permeance element 223 is disposed between two first magnetic elements 222, the generated magnetic flux density therebetween can be increased.

FIG. 4B is a schematic diagram showing the movement of the linear permanent magnetic apparatus 2 of the present invention. The poles of the first magnetic element 222 can attract or repulse the poles of the second magnetic element 211 so as to generate a net force F for moving the rotor structure 21, thereby horizontally moving the rotor structure 21 by a distance D.

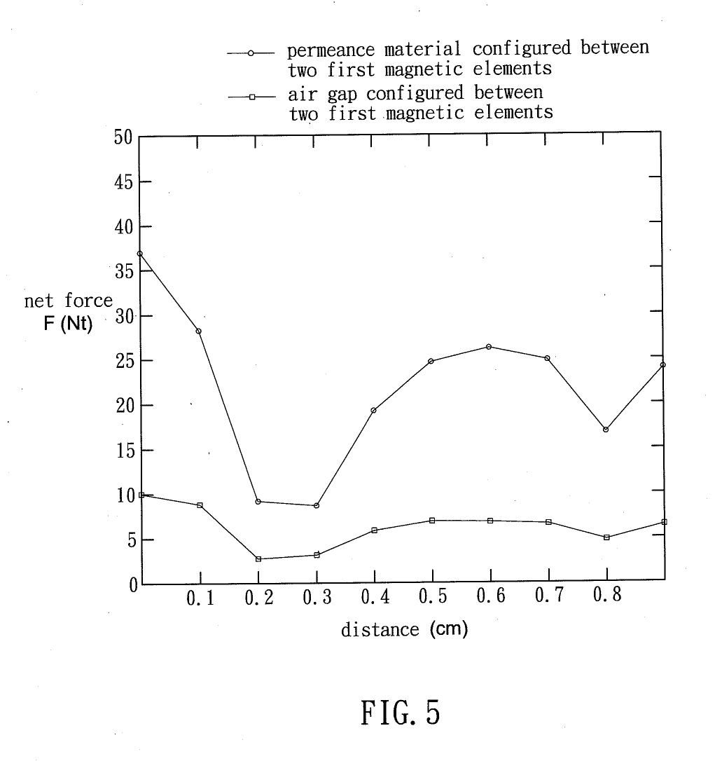

FIG. 5 is a schematic diagram showing the comparison result between the output net forces of the permanent magnetic apparatus 2 of the present invention and the conventional linear permanent magnetic motor disclosed by Howard R. Johnson. In FIG. 5, the X-coordinate represents the horizontal move distance (cm), and the Y-coordinate represents the output net force F (Nt) of the permeance apparatus (motor). Besides, the circles shown in FIG. 5 represent the output net force F of the permanent magnetic apparatus 2 of the present invention, which has a second permeance element 223 configured between two first magnetic elements 222, while the squares represent the output net force F of the conventional linear permanent magnetic motor disclosed by Howard R. Johnson, which has an air gap between two stator magnets.

As shown in FIG. 5, in the stator structure 22 of the linear permanent magnetic apparatus 2 of the present invention, the space between two first magnetic elements 222 is occupied by the second permeance element 223, so that the generated magnetic flux density between two first magnetic elements 222 is higher. Accordingly, when the poles of the first magnetic element 222 are disposed opposite to those of the second magnetic element 211, the generated attractive and repulsive forces are larger. Thus, the net force F outputted by the permanent magnetic apparatus 2 is larger than that of the conventional linear permanent magnetic motor disclosed by Howard R. Johnson. As a result, the permanent magnetic apparatus 2 can provide larger output net force.

To sum up, in the rotational permanent magnetic apparatus of the present invention, the outer periphery of the first permeance element of the rotor structure has a plurality of grooves disposed separately, and the first magnetic elements are correspondingly disposed in the grooves, respectively. Accordingly, the magnetic flux density between two first magnetic elements is increased. Compared with the convention rotational permanent magnetic motor (disclosed by Howard R. Johnson), the present invention can generate larger attractive and repulsive forces when the first magnetic element of the rotor structure is located opposite to the second magnetic element of the stator structure. This configuration can generate larger net force to drive the rotor structure to rotate, so that the permanent magnetic apparatus can have larger output torque. In addition, since the first permeance element is disposed between two first magnetic elements of the rotor structure, compared with the conventional rotational permanent magnetic motor, the rotor structure of the present invention has stronger structural strength. Thus, the lifespan of the permanent magnetic apparatus is increased.

In the linear permanent magnetic apparatus of the present invention, the first magnetic elements are separately disposed at one side of the first permeance element and form a plurality of separate grooves, and the second permeance elements are correspondingly disposed in the grooves. Accordingly, the magnetic flux density between two first magnetic elements of the stator structure is increased. Compared with the convention linear permanent magnetic motor (disclosed by Howard R. Johnson), the present invention can generate larger attractive and repulsive forces when the first magnetic element of the stator structure is located opposite to the second magnetic element of the rotor structure. This configuration can output larger net force than the conventional linear permanent magnetic motor does. Thus, the permanent magnetic apparatus of the present invention has larger output driving force.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A permanent magnet apparatus, comprising:
a rotor structure having a first permeance element and a plurality of first magnetic elements, wherein the outer periphery of the first permeance element has a plurality of grooves disposed separately, and the first magnetic elements are correspondingly disposed in the grooves; and
a stator structure disposed at the outer periphery of the rotor structure, and having a plurality of second magnetic elements around the rotor structure.

2. The permanent magnet apparatus of claim 1, wherein the first magnetic elements are disposed in the grooves, respectively, by wedging, locking, adhering, or their combinations.

3. The permanent magnet apparatus of claim 1, wherein the first magnetic elements are closely attached to the grooves respectively.

4. The permanent magnet apparatus of claim 1, further comprising:
a shaft disposed through the first permeance element.

5. The permanent magnet apparatus of claim 1, wherein the stator structure further has a second permeance element disposed around the rotor structure, and the second magnetic elements are disposed in the second permeance element.

6. The permanent magnet apparatus of claim 5, wherein the second magnetic elements are disposed in the second permeance element by wedging, locking, adhering, or their combinations.

7. A permanent magnet apparatus, comprising:
a stator structure having a first permeance element, a plurality of first magnetic elements, and a plurality of second permeance element, wherein the first magnetic elements are separately disposed at one side of the first permeance element and form a plurality of separate grooves, and the second permeance elements are correspondingly disposed in the grooves; and
a rotor structure having at least a second magnetic element disposed opposite to the stator structure.

8. The permanent magnet apparatus of claim 7, wherein the second permeance elements are disposed in the grooves by wedging, locking, adhering, or their combinations.

9. The permanent magnet apparatus of claim 7, wherein the second permeance elements are closely attached to the grooves respectively.

10. The permanent magnet apparatus of claim 7, wherein the first permeance elements and the second permeance elements are integrally formed as one piece.
